(19) United States
(12) Patent Application Publication
(10) Pub. No.: US 2010/0000049 A1
(43) Pub. Date: Jan. 7, 2010

(54) INTERFERENCE ASSEMBLY, HINGE UTILIZING THE SAME, AND COLLAPSIBLE DEVICE UTILIZING THE HINGE

(75) Inventor: CHUNG-YI LIN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/233,551

(22) Filed: Sep. 18, 2008

(30) Foreign Application Priority Data
Jul. 2, 2008 (CN) 200820301416.7

(51) Int. Cl. E05D 11/10

(52) U.S. Cl. 16/340

(57) ABSTRACT

A interference assembly includes first and second elements, each of which includes a mating side, both of which face each other. Two fixing portions extend from the first mating side. The second mating side defines a first fixing slot and a second fixing slot. A first sliding portion is angled on the second mating side between an end of the first fixing slot and an end of the second fixing slot. A second sliding portion is angled on the second mating side between the opposite end of the first fixing slot and the opposite end of the second fixing slot. One of the fixing portions may engage in the first fixing slot and move along the first sliding portion, and the other may engage the second fixing slot and move along the second sliding portion. A hinge utilizing the assembly and a collapsible device utilizing the hinge are also disclosed.

### BACKGROUND

1. Field of the Invention

The present invention relates to an interference assembly, a hinge utilizing the same, and a collapsible device utilizing the hinge.

2. Description of Related Art

A collapsible device, such as a notebook computer or clamshell mobile phone, generally includes one part and a second part hinged thereon. To prevent the two parts from potential damage when rotating together, the hinge generally includes a first element and a second element positioning the parts during rotation. The first element includes a first raised portion and a second raised portion. The second element includes a first depressed portion and a second depressed portion. When the first element is rotated relative to the second element, the first and second raised portions engage the first and second depressed portions, resulting in friction between the first and second elements, causing difficulty in opening.

### BRIEF DESCRIPTION OF THE DRAWINGS

FIG. 1 is an exploded, isometric view of an embodiment of a hinge including an interference assembly.

FIG. 2 is an assembled, isometric view of the hinge of FIG. 1.

FIG. 3 is an exploded, isometric view of the interference assembly of FIG. 1, including a first element and a second element.

FIG. 4 is an assembled, isometric view of a collapsible device including the hinge of FIG. 1.

FIG. 5 is an assembled, isometric view of the interference assembly of FIG. 3.

FIG. 6 is another assembled, isometric view of the interference assembly of FIG. 3, with the first and second elements rotated relative to each other.

FIG. 7 is an assembled, isometric view similar to FIG. 6, with the first element rotated by a different angle relative to the second element.

### DETAILED DESCRIPTION

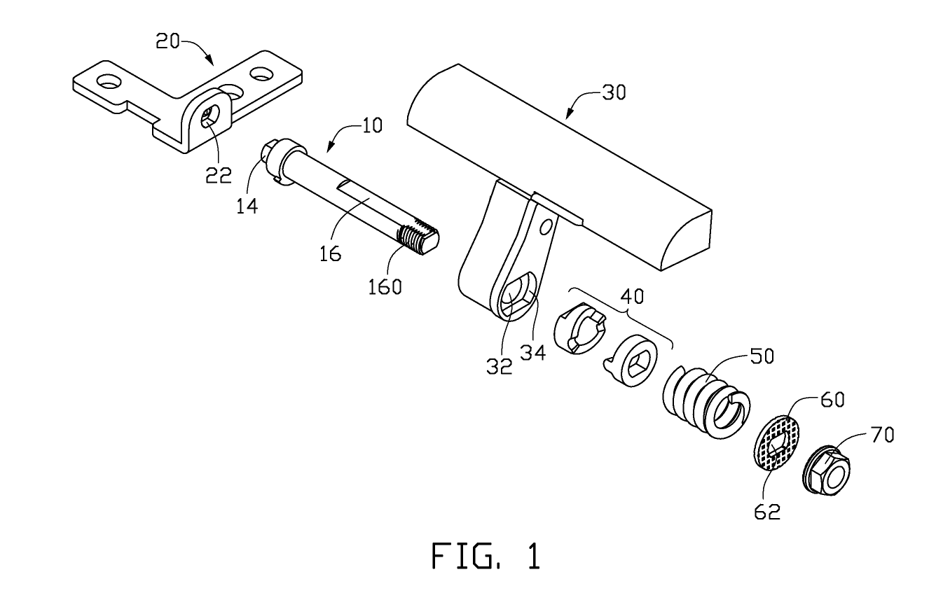

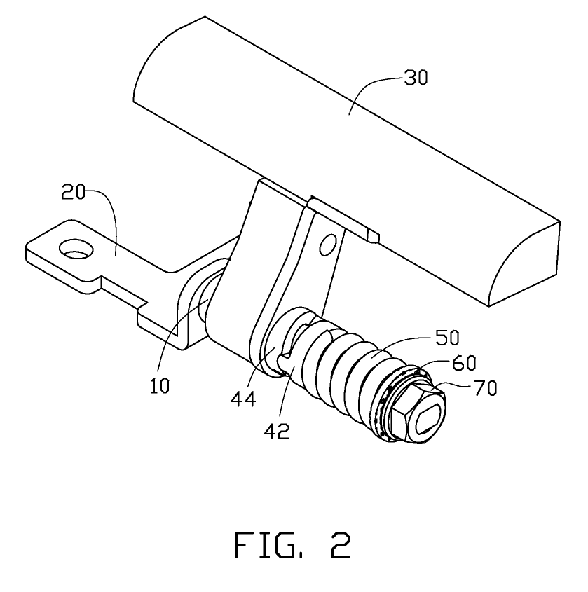

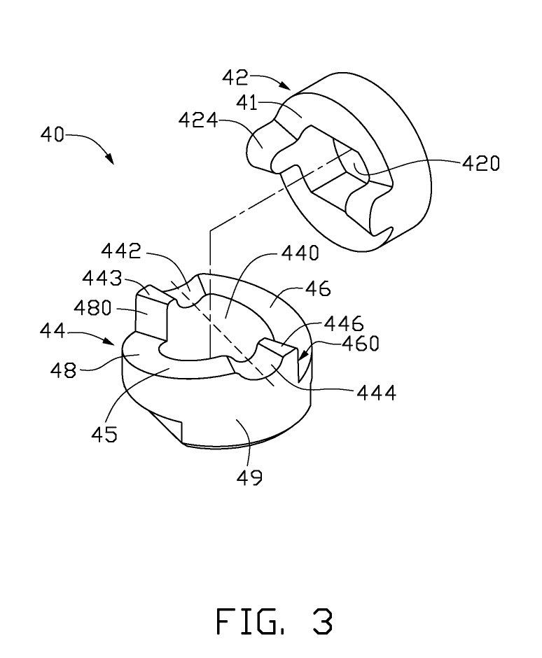

Referring to FIGS. 1 through 3, a hinge of an embodiment includes a shaft 10, a first bracket 20, a second bracket 30, an interference assembly 40, a resilient member 50, a washer 60, and a fastener 70. In this embodiment, the fastener 70 is a nut, and the resilient member 50 is a coil spring defining a through hole.

The shaft 10 includes a non-cylindrical conjoining portion 14, and a non-cylindrical post 16 opposite thereto. A distal end of the post 16 forms a threaded portion 160.

The first bracket 20 defines a non-circular fastening hole 22.

The second bracket 30 is T-shaped and defines a depressed portion 34 in a side of a lower part, facing the interference assembly 40. A circular through hole 32 is defined in the lower part of the second bracket 30, extending through a bottom of the depressed portion 34 and out the opposite side of the lower part.

The interference assembly 40 includes a first element 42, and a second element 44 engaging and rotating relative to the first element 42.

The first element 42 is generally cylindrical. The first element 42 defines a non-circular fixing hole 420 through the central portion of the first element 42. The fixing hole 420 extends through a first mating side 41 and out the opposite side, configured for snugly fitting about the non-cylindrical post 16 of the shaft 10. Two symmetrical fixing portions 424 perpendicularly extend from the first mating side 41. The fixing portions 424 are opposite to each other across the fixing hole 420.

The second element 44 is generally cylindrical. The second element 44 defines a circular through hole 440 through the central portion of the second element 44. The through hole 440 extends through a second mating side 45 and out the opposite side. The second mating side 45 faces the first mating side 41. The second mating side 45 defines a first fixing slot 442, and a second fixing slot 444 opposite to the first fixing slot 442 across the through hole 440. A first connecting portion 443 connected to one end of the first fixing slot 442 extends from the second mating side 45. A second connecting portion 446 extends from the second mating side 45, and connects to one end of the second fixing slot 444. The second fixing slot 442 is opposite to the first connecting portion 443. A first sliding portion 46 is formed on the second mating side 45, extending at an angle from the other end of the first fixing slot 442 towards the second connecting portion 446. The second connecting portion 446 includes a resisting surface 460, facing the first sliding portion 46. A second sliding portion 48 is formed on the second mating side 45, extending at an angle from the other end of the second fixing slot 444 towards the first connecting portion 443. The first connecting portion 443 includes a resisting surface 480, facing the second sliding portion 48. A mounting portion 49 extends from the side opposite to the second mating side 45 of the second element 44.

The washer 60 defines a non-circular through hole 62 through the center thereof, for snugly fitting about the post 16 of the shaft 10.

In assembly, the conjoining portion 14 of the shaft 10 is inserted into and fixed in the fastening hole 22 of the first bracket 20, such that the shaft 10 rotates together with the first bracket 20. The post 16 is passed though the through hole 32, the through hole 440, the fixing hole 420, the through hole of the resilient member 50, and the through hole 62 in turn, to engage with the fastener 70 via its threaded portion 160. The fastener 70 is configured for preventing the interference assembly 40, the resilient member 50, and the washer 60 from disengaging from the shaft 10. The first mating side 41 faces the second mating side 45. The mounting portion 49 of the second element 44 is inserted into and fixed to the depressed portion 34. One end of the resilient member 50 resists against the side opposite to the first mating side 41 of the first element 42, with the other end resisting against the washer 60.

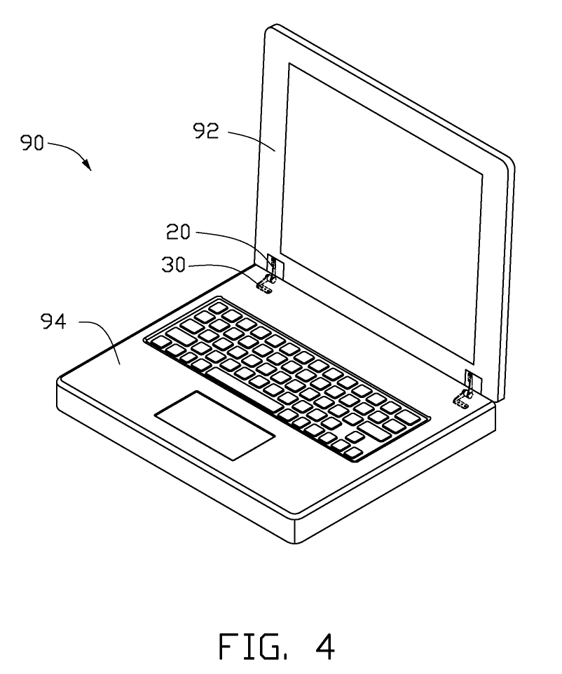

Referring also to FIG. 4, in use, the second bracket 30 is fixed to a base 94 of a collapsible device 90, here a notebook computer. The first bracket 20 is fixed to a cover 92 of the collapsible device 90, and is synchronously rotatable with the cover 92 relative to the base 94.

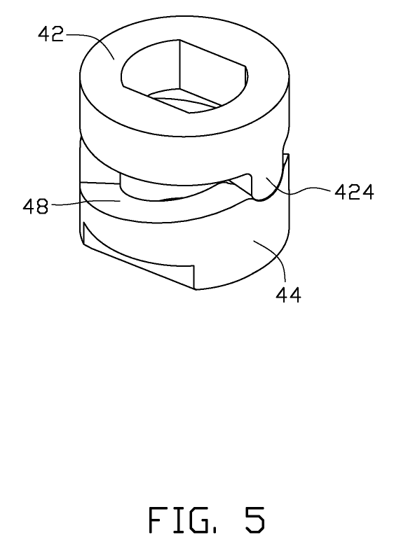

Referring also to FIG. 5, when the cover 92 closes with the base 94, the fixing portions 424 of the first element 42 engage the first and second fixing slots 442, 444 of the second element 44, and the resilient member 50 is distorted.

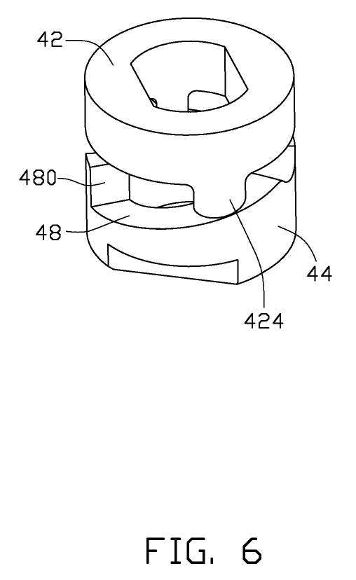

Referring also to FIG. 6, when the cover 92 opens from the base 94, the first element 42 and the shaft 10 rotate with the cover 92. The first element 42 is rotated relative to the second element 44. Thereby, one of the fixing portions 424 is moved away from the first connecting portion 443. The other fixing portion 424 is moved away from the second connecting portion 446. When the fixing portions 424 are completely disengaged from the first and second fixing slots 442, 444, one of the fixing portions 424 is impelled along the first sliding portion 46, and the other fixing portion 424 is impelled along the second sliding portion 48. The resilient member 50 restores and moves the first element 42 towards the second element 44 fluidly and smoothly, enabling easy and trouble-free opening of the cover 92.

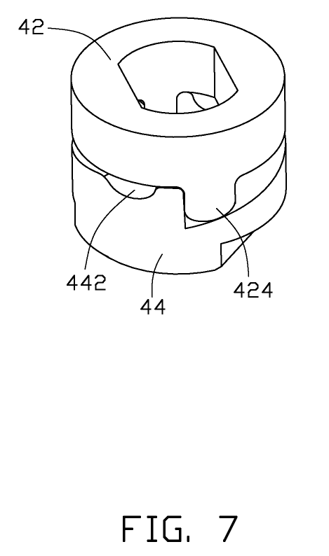

Referring also to FIG. 7, when the fixing portions 424 of the first element 42 resist the first and second resisting surfaces 460, 480 of the second element 44, the cover 92 cannot be rotated.

When closed, the cover 92 moves towards the base 94. One of the fixing portions 424 is moved upward along the first sliding portion 46 towards the first fixing slot 442. The other fixing portion 424 is moved upward along the first sliding portion 48 towards the second fixing slot 444. The first element 42 moves away from the second element 44 along an axis. As closing movement, one of the fixing portions 424 moves onto an edge of the first slot 442, and the other fixing portion 424 moves onto an edge of the second slot 444. At this point, the cover 92 may be physically released because the cover 92 can continue to rotate by force of inertia, but lightly so as not to impact the base 94. When the fixing portions 424 are completely engaged with the first and second fixing slots 442, 444, the cover 92 has closed on the base 94.

It is believed that the present embodiment and its advantages will be understood from the foregoing description, and it will be apparent that various changes may be made thereto without departing from the spirit and scope of the description or sacrificing all of its material advantages, the example hereinbefore described merely being an exemplary embodiment.

What is claimed is:

1. An interference assembly, comprising:
a cylindrical first element comprising:
a first mating side; and
a first fixing portion and a second fixing portion formed from the first mating side; and
a cylindrical second element comprising:
a second mating side facing the first mating side of the first element;
a first fixing slot and a second fixing slot defined in the second mating side; and
a first sliding portion angled on the second mating side between an end of the first fixing slot and an end of the second fixing slot, and a second sliding portion angled on the second mating side between the opposite end of the first fixing slot and the opposite end of the second fixing slot;
wherein the first fixing portion engages the first fixing slot, and slides along the first sliding portion; the second fixing portion engages the second fixing slot, and slides along the second sliding portion.

2. The interference assembly of claim 1, wherein the first element defines a fixing hole through the center thereof; and the first and second fixing portions are opposite to each other across the fixing hole.

3. The interference assembly of claim 1, wherein the second element defines a through hole through the center thereof; and the first and second fixing slots are opposite to each other across the through hole.

4. The interference assembly of claim 1, wherein a first connecting portion extends from the second mating side of the second element, and connects to the opposite end of the first fixing slot;
a second connecting portion extends from the second mating side of the second element, and connects to the end of the second fixing slot;
the first sliding portion angles down from the end of the first fixing slot towards the second connecting portion; and
the second sliding portion angles down from the opposite end of the second fixing slot towards the first connecting portion.

5. The interference assembly of claim 4, wherein a first resisting surface is formed from the first connecting portion, facing the second sliding portion;
a second resisting surface is formed from the second connecting portion, facing the first sliding portion; and
the first and second fixing portions resist against the first and second resisting surfaces.

6. A hinge comprising,
a first bracket;
a second bracket;
a shaft fixed to and capable of rotating with the first bracket, the shaft passed through and rotated relative to the second bracket;
an interference assembly mounted to the shaft comprising;
a cylindrical first element comprising:
a first mating side; and
a first fixing portion and a second fixing portion formed from the first mating side; and
a cylindrical second element comprising:
a second mating side facing the first mating side of the first element;
a first fixing slot and a second fixing slot defined in the second mating side; and
a first sliding portion angled on the second mating side between an end of the first fixing slot and an end of the second fixing slot, and a second sliding portion angled on the second mating side between the opposite end of the first fixing slot and the opposite end of the second fixing slot;
an resilient member mounted to and moving along the shaft, configured for pressing the interference assembly; and
a fastener fixed to a distal end of the shaft;
wherein the first fixing portion engages the first fixing slot, and slides along the first sliding portion; the second fixing portion engages the second fixing slot, and slides along the second sliding portion.

7. The hinge of claim 6, wherein the first element defines a fixing hole through the center thereof for fitting about the shaft; and the first and second fixing portions are opposite to each other across the fixing hole.

8. The hinge of claim 6, wherein the second element defines a through hole through the center thereof for fitting about the shaft; and the first and second fixing slots are opposite to each other across the through hole.

9. The hinge of claim 6, wherein a first connecting portion extends from the second mating side of the second element, and connects to the opposite end of the first fixing slot;
a second connecting portion extends from the second mating side of the second element, and connects to the end of the second fixing slot;
the first sliding portion angles down from the end of the first fixing slot towards the second connecting portion; and
the second sliding portion angles down from the opposite end of the second fixing slot towards the first connecting portion.

10. The hinge of claim 9, wherein a first resisting surface is formed from the first connecting portion, facing the second sliding portion;
a second resisting surface is formed from the second connecting portion, facing the first sliding portion; and
the first and second fixing portions resist against the first and second resisting surfaces.

11. The hinge of claim 6, wherein the shaft comprises a conjoining portion;
the first bracket defines a fastening hole; and
the conjoining portion is inserted into and fixed in the fastening hole.

12. The hinge of claim 6, wherein the shaft comprises a non-circular post, and the second bracket, the interference assembly, and the resilient member are fitted about the post;
the fasteners are mounted to a distal end of the post, to prevent the second bracket, the interference assembly, and the resilient member from disengaging from the shaft;
the second bracket defines a depressed portion in a side and a through hole, the through hole extends through a bottom of the depressed portion and out the opposite side of the second bracket, and the post passes through the through hole; and
a mounting portion extends from the second element, inserted into and fixed to the depressed portion.

13. The hinge of claim 6, further comprising a washer fixed to the shaft between the resilient member and the fastener.

14. The hinge of claim 13, wherein the resilient member is a coil spring, one end of which resists against the washer, and the other end resists against the interference assembly.

15. A collapsible device comprising:
a base;
a hinge comprising an interference assembly, the interference assembly comprising:
a cylindrical first element comprising:
a first fixing portion and a second fixing portion formed on a first mating side of the first element; and
a cylindrical second element comprising:
a first fixing slot and a second fixing slot defined in a second mating side of the second element; and
a first sliding portion formed on the second mating side between an end of the first fixing slot and an end of the second fixing slot, a second sliding portion formed on the second mating side between the opposite end of the first fixing slot and the opposite end of the second fixing slot, the first sliding portion angling down from the end of the first fixing slot towards the second fixing slot, the second sliding portion angling down from the opposite end of the second fixing slot towards the first fixing slot; and
a cover hinged on the base via the hinge;
wherein a distal end of the hinge is fixed to the base, and a proximal end of the hinge is mounted to the cover; the first and second fixing portions engage the first and second fixing slots when the cover is covered on the base; and the first and second fixing portions move along the first and second sliding portions when the cover rotates relative to the base.

16. The collapsible device of claim 15, wherein the first element defines a fixing hole through the center thereof; and the first and second fixing portions are opposite to each other across the fixing hole.

17. The collapsible device of claim 15, wherein the second element defines a through hole through the center thereof; and the first and second fixing slots are opposite to each other across the through hole.

18. The collapsible device of claim 15, wherein a first connecting portion extends from the second mating side of the second element, and connects to the opposite end of the first fixing slot;
a second connecting portion extends from the second mating side, and connects to the end of the second fixing slot; and
the first sliding portion angles down from the end of the first fixing slot towards the second connecting portion, and the second sliding portion angles down from the opposite end of the second fixing slot towards the first connecting portion.

19. The collapsible device of claim 18, wherein a first resisting surface is formed from the first connecting portion, facing the second sliding portion;
a second resisting surface is formed from the second connecting portion, facing the first sliding portion; and
the first and second fixing portions resist against the first and second resisting surfaces when the cover is open to a greatest angle relative to the base.
